(19) United States
(12) Patent Application Publication
(10) Pub. No.: US 2002/0102988 A1
(43) Pub. Date: Aug. 1, 2002

(54) Wireless communication system and method for sorting location related information

(75) Inventor: Jussi Petri Myllymaki, San Jose, CA (US)

Correspondence Address: FREDERICK W. GIBB, III, MCGINN & GIBB, PLLC, 2568-A RIVA ROAD, SUITE 304, ANNAPOLIS, MD, 21401, US

(73) Assignee: International Business Machines Corporation, Armonk, NY (US)

(21) Appl. No.: 09/769,452

(22) Filed: Jan. 26, 2001

(51) Int. Cl. H04Q 7/20

(52) U.S. Cl. 455/456

(57) ABSTRACT

A system and method for sorting information that has particular significance at a specific location only to those individuals that are at or near that geo-spatial location. The system includes a GPS client wireless component that can be a personal wireless communication device (such as Palm Pilot, cellular digital phones, etc.) or personal computer configured for use within a global position satellite network.

### BACKGROUND OF THE INVENTION

1. Field of the Invention

This invention generally relates to wireless communication components and more particularly to wireless communication integration of such components, and sorts personal information based upon either conventional or global position satellite (GPS) equipped wireless components, and location identified data.

2. Description of the Related Art

Rapid advances are being made in the field of wireless communication. An increasing number of applications are being developed for the wireless device platform, ranging from smart cellular phones to two-way text pagers. By the year 2001, cellular phone network operators are required to have the capability to determine the physical location of a cellular phone. Possible ways of accomplishing this include triangulation based on cellular network signals and data, and the use of global position satellite (GPS) sensors embedded in cellular phones. The capability to track the physical location of cellular phones and other wireless devices gives rise to systems that deliver real-time, location-based information and services to wireless subscribers.

Typically, a wireless application retrieves data from a server to the wireless handset when the user invokes a specific function in the handset. For instance, a user might request flight departure time information from the server of an airline. In many cases, however, it is desirable to deliver (“push”) information to the user on a continuous basis. As the use of mobile devices becomes more prevalent, users will also become more dependent on the data they carry with them. Given that the displays in mobile devices are typically very limited in size, it is very difficult for mobile users to retrieve and browse the data they carry. For instance, today's cellular phones can store hundreds of telephone numbers, yet the mechanism for selecting a number from the directory is cumbersome. The user either has to scroll through the entire listing to find the number to call, or he/she has to type in the name (or part thereof) of the party to call. The limited functionality of keyboards in mobile devices complicates this process. Thus, there is need for the ability to sort information based upon geo-spatial location to suit a user's needs when using wireless-based components.

### SUMMARY OF THE INVENTION

It is a principal object of the present invention to provide a system and method for sorting information that has significance to a user at a geo-spatial location that automatically occurs when at that location by virtue of tracking information provided by either the local wireless provider network or a global positioning satellite based wireless component. The system of the invention includes either a conventional or GPS-type client wireless component (CWC) and location identified data in a document database used by either type of these CWCs. Such components can be a wireless Personal Digital Assistant (PDA) communication device, digital phones, etc. or a personal computer configured for use within a local wireless network.

It is therefore an object of the invention to provide a system and method of sorting geo-spatial dependent data using a client wireless component (CWC), wherein the method includes determining location of a user of the CWC, storing the location of the CWC; accessing a document database whose datum has location identifiers, and sorting the document database in a location-dependent order by calculating a distance between the user's location and the location identifiers associated with the datum in the document database.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic diagram of a hardware system adapted to implement the invention;

FIG. 2 shows a system for location-based sorting of personal information; and

FIG. 3 is a flowchart diagram showing the operation of the system shown in FIG. 2 according to the invention.

### DETAILED DESCRIPTION OF PREFERRED EMBODIMENTS OF THE INVENTION

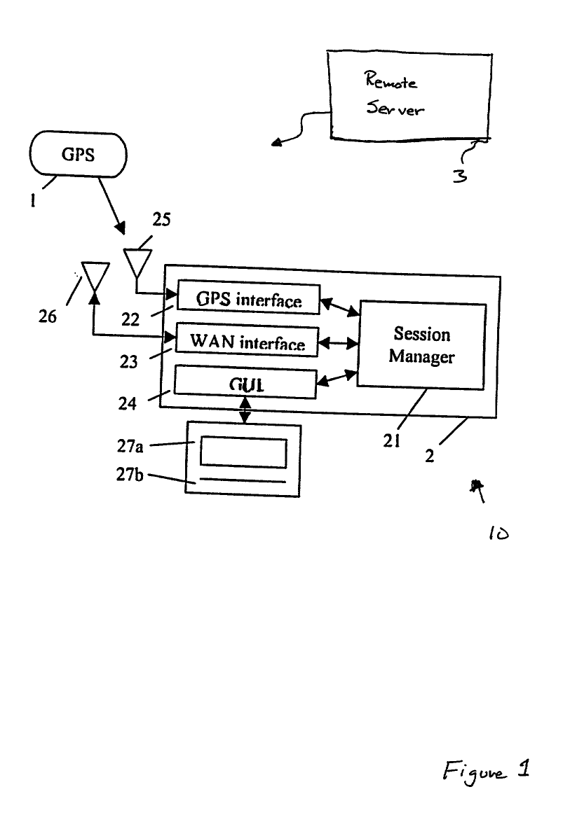

The purpose of this invention is to use conventional wireless components and global positioning satellite-based wireless components with a geo-spatial activated sorting system and method. An exemplary implementation of system hardware of the invention is shown in FIG. 1. The proximity sorting system 10 includes two main components: a client wireless component (CWC) 2 (both conventional and GPS-type CWC's) and a local wireless provider through a server 3.

As illustrated in FIG. 1, a typical configuration of an information handling/wireless communication system in accordance with the invention has central processing units in both the wireless component 2 and the server 3. Each of these central processing units could include various mapping units, weighting units, classification units, clustering units, filters, adders, subtractors, comparators, etc. Alternatively, as would be known by one ordinarily skilled in the art given this disclosure, multiple specialized CPU's (or other similar individual functional units) could perform the same processing, mapping, weighting, classifying, clustering, filtering, adding, subtracting, comparing, etc. Moreover, although the stored databases as shown in FIG. 1 preferably are stored in the wireless component 2, specialized databases can be-incorporated in the remote server 3 wherein the user for accessing data remotely (e.g. telephone directories and Internet access). GPS 1 is the existing GPS satellite network.

When using the server 3, a wide area network (WAN) interface 23 is used to transmit information from the remote server 3 to the GPS-type client wireless component 2. A global positioning satellite GPS 1 transmits positional information to the wireless component 2 through antenna 25. Antennas 26 and 25 can be separate or combined. The GPS Client Wireless Component 2 (CWC) may be implemented on a laptop computer, cell phone, personal digital assistant (PDA) or integrated in a car system having a wireless wide area network (WAN) connection 23 for communicating with the server 3. CWC in one form includes a GPS interface 22 for receiving location information to assist a Location Tracker 110 as discussed below. Tasks of this component are to know where the location of the current user is. The current location of the CWC can be provided by either the GPS signal received, local network server identifier or telephone area code used, or words input to the CWC.

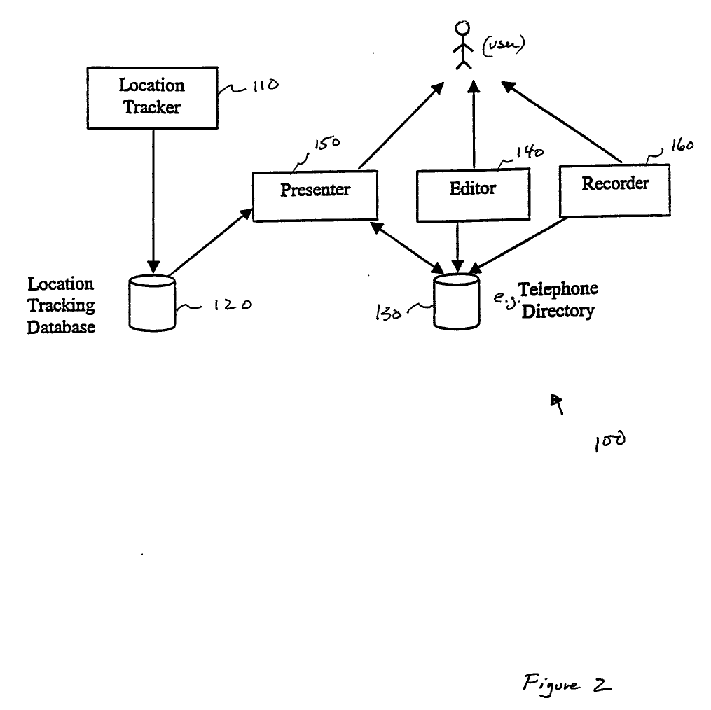

The client wireless component 2 operates under the control of the respective session manager 21. The session manager 21 is responsible for the interaction between the subcomponents of the CWC and desired functionality of the CWC for a particular application. In particular, as discussed below and shown in FIG. 2, it includes components to enable sorting functioning capability based upon geo-spatial location of the user. The CWC 2 tracks location by the Location Tracker 110, stores the current location of the user in the Location Tracker Database 120, provides access to a Document Database 130, includes an Editor 140 so as to be able to manipulate documents in the Document Database 130, includes a Presenter 150 used for retrieving documents from the Document Database and sorting according to a user's needs, and includes a Recorder 160 that allows a user to record the position of a document that does not have an inherent location associated with it.

The GPS interface 22 is implemented as a miniaturized GPS receiver that measures the time a radio signal needs from a GPS satellite in the GPS system 1 until it arrives at the GPS antenna 25. Knowing the speed of the radio signal (approximately the speed of light), and when each signal is transmitted, the distance to each of the satellite can be determined. The final solution of the equations produces an exact position of the antenna 25 (latitude, longitude). The GPS receiver interface 22 determines a current location of the GPS client wireless component 2 and supplies the current location to the session manager 21. An example of such GPS wireless component are disclosed in U.S. Pat. No.6,144,336.

The WAN interface 23 supports a wireless connection to the Internet. With this interface the GPS client wireless component 2 can always be connected to a server 3. The graphic user interface 24 (GUI) is implemented in GPS client wireless component 2 for an easy-way to configure and to administrate the GPS client wireless component 2. A GPS antenna 25 connects to the GPS interface 22 to receive GPS data from the GPS satellite system.

The WAN transceiver antenna 26 is for the wireless connection to the Internet. It is connected to the WAN interface 23 of the GPS client wireless component 2. The output device 27a may be implemented as a display of a wireless device end the input device 27b as a touch screen. The touch screen is used for manual user inputs and configuration. The display is for output of messages.

When using the system 10 a user's location information is sorted by personal information into a “nearest first” order. One example of personal information is a personal telephone directory stored in user's cellular phone. As an example, when a business traveler departs from San Francisco and subsequently arrives in New York, the telephone numbers of his New York contacts are listed first in the directory. Then it is a relatively easy task to scroll through the first few entries and select the local party to call. When the user returns to San Francisco, the contacts in that city will be displayed at the top of the list.

Referring now to FIG. 2, the system 100 is described as follows with components that include: the Location Tracker 110; the Location Tracking Database 120; the Document Database 130; the Editor 140; the Presenter 150; and the Recorder 160. The methodology comprises actions that are discussed as the components are introduced.

The Location Tracker 110 is responsible for determining the current location of the user from available sources. Possible sources include the Location Tracker of a wireless device (e.g. cellular telephone with built-in GPS module), location information retrieved from the wireless network (e.g. telephone area code(s) in current location), and explicit entry by the user (e.g. enter city name). The information is marked with a timestamp and inserted into the Location Tracking Database 120 (Step 1 in FIG. 1). Only the latest location information is stored in the Database. Location information that exists in the Database but is older than the information currently being inserted is removed from the Database.

The Location Tracking Database 120 stores the current location of the user. The coordinate may be a physical location such as a GPS coordinate pair (latitude and longitude), or it may be semantic (e.g. city of New York, or IBM Yorktown laboratory). The location information is timestamped so that the time when the location was captured is known. Thus, the database records have the following schema: location (timestamp, type, content) where timestamp contains the date and time, type indicates the type of location information (e.g. GPS coordinate, building, or address), and content is the location value in the given type.

The Document Database 130 stores the user's documents, for instance telephone directory, to-do list, address book, and e-mail. Documents have an optional location identifier which may be automatically determined from the content of the document (e.g. area code of a telephone number, or city name of a contact in the address book). The location identifier may also be manually assigned by the user by using the Recorder component. The schema of the records in the database is: document(Ltype, location, Ctype, content) were Ltype indicates the type of the location information (corresponding to the type attribute in Location Tracking Database), location contains the location value in the given location type, Ctype indicates the type of a document (e.g. telephone directory, address book), and content contains the document.

The Editor 140 allows the user to manipulate documents in the Document Database (step 2). The Editor 140 provides a mechanism to add, edit, and delete documents, and is comparable to the Personal Information Manager (PIM) application found in many Personal Digital Assistants (PDAs). The Editor 140 also allows the user to manually edit the location information associated with documents. This edit function is complemented by the Recorder 160 that allows the user to associate the current location instead of a location entered manually.

The Presenter 150 is responsible for retrieving documents from the Document Database 130, and arranging them in a location-dependent order for presentation to the user. It does this by calculating the distance between the user's current location (retrieved from the Location Tracking Database) (step 3) and the location information associated with each document (retrieved from the Document Database 130) (step 4).

The distance is a metric expressed in either a physical dimension (miles, degrees latitude/longitude) or a logical dimension (number of street blocks, number of network hops). Once the documents are retrieved from the Document Database 130, they are sorted according to distance and presented to the user (step 5). A shortest-distance-first sort order allows the Presenter 150 to display those documents first that are most closely (distance-wise) related to the user's current location. For instance, a user on a business trip will find his/her cellular phone directory displayed so that numbers residing in the same area code as the user's current location will be listed first. This greatly reduces the effort required to find the local phone numbers of the user's business partners.

If the user's Document Database contains data from external databases (e.g. commercial establishment directories, restaurant guides, and travel guides), that data is also sorted and made easy to access based on the user's location. A typical example of this capability is to list the names and telephone numbers of restaurants in the user's vicinity. Listing the addresses and telephone numbers of nearby hospitals, retail stores, and concert and sports venues would also be made possible by the capability to sort by distance.

The Recorder 160 allows the user to record the position of a document that does not have an inherent location associated with it. For instance, a user who travels to visitsa client may want to associate documents that relate to that client, to the client's location. That way, when the user visits the client next time, the documents will appear first in a file browser.

The Recorder 160 provides an interface as part of the Presenter 150 user interface that allows the user to add, modify, and delete the location information associated with a document (step 6). For convenience, a special button on the keypad of a mobile-type CWC device may be allocated to this. For instance, on a cellular phone, a special key can be assigned to the task “Mark Here” that associates the user's current location with the document that was selected. The location information is stored in the Document Database.

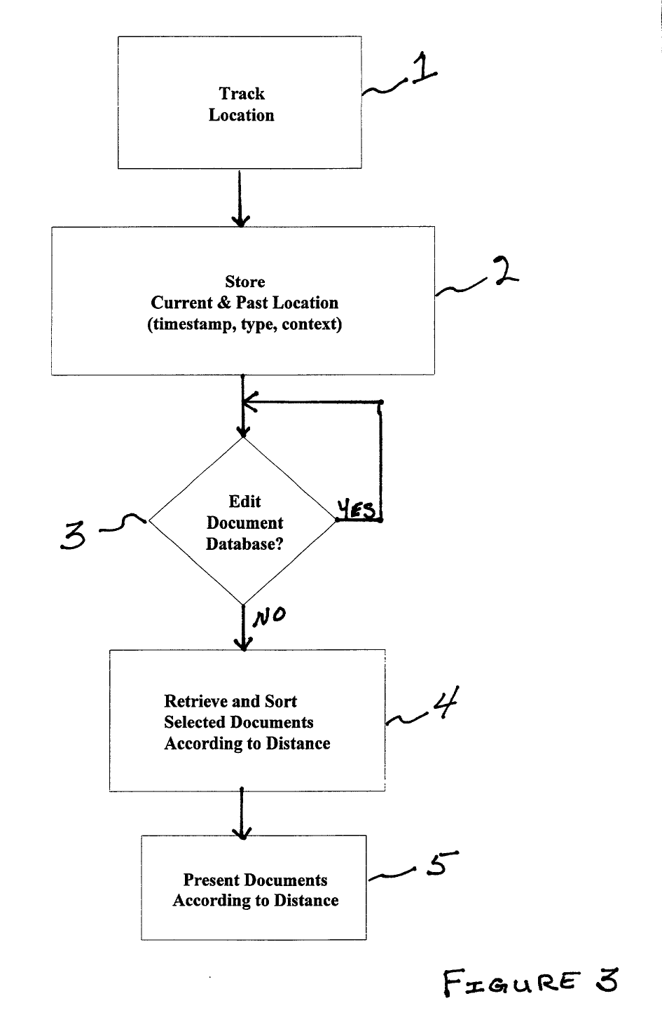

Referring now to FIG. 3, a flowchart diagram shows how the system 100 operates. At step 1, the Location Tracker 110 determines current location of the user from the available sources. From this, in step 2, this location information is stored in the Location Database with timestamp, type and content. Next in step 3, the Document Database 130 is edited by adding, deleting or arbitrarily assigning a location for certain data as required as discussed above using either the Editor 140 or Recorder 160. In step 4, the Document Database is sorted in accordance with Distance as defined above. Finally, in step 5, the sorted data is provided to the user in a sorted format for viewing.

The primary benefit of this invention is to make it easier for the user of a wireless devices to browse, select, and use the information stored in the wireless device. Current and future wireless devices can carry much more information than what can be conveniently accessed. Small displays and limited input devices such as keyboards make it hard to use the data. Presenting the data in location-based sort order allows the user to access local information with minimum effort, for instance with one keystroke instead of 10 or more when scrolling through a long telephone directory listing.

A secondary benefit of this invention is to increase the user's awareness of local information, even if that information is not explicitly selected or used (as in the case of a telephone number). The user benefits from knowing the names, addresses, and telephone numbers of nearby hospitals and commercial establishments (e.g. auto repair facilities), creating a sense of security.

While the overall methodology of the invention is described above, the invention can be embodied in any number of different types of hardware systems and executed in any number of different ways, as would be known by one ordinarily skilled in the art. For example, the invention can be used as part of a “Tempus Fugit” system (registered trademark and designed by International Business Machines) and offer location based sorting of calendar data, contact information and to-do lists.

In summary, the invention provides more functionality and ease of using wireless devices by providing the ability to sort information based upon geo-spatial location to suit a user's needs automatically, using either GPS-equipped or conventional wireless handsets.

While the invention has been described in terms of preferred embodiments, those skilled in the art will recognize that the invention can be practiced with modification within the spirit and scope of the appended claims.

What is claimed is:

1. A method of sorting geo-spatial dependent data using a client wireless component (CWC), said method comprising:
determining a location of said CWC;
accessing a document database whose datum have a location identifiers; and
sorting said document database in a location-dependent order based on a distance between said location of said CWC and said location identifiers associated with said datum in said document database.

2. The method in claim 1, wherein said determining of said location of said CWC includes providing a global position satellite (GPS)-type CWC and tracking location of said GPS-type CWC using global positioning satellites.

3. The method in claim 1, wherein said determining of said location of said CWC includes accessing an area code of a local wireless cellular network.

4. The method in claim 1, wherein said determining of said location of said CWC includes explicit entry of location data.

5. The method in claim 1, further comprising storing said location into said CWC by inputting said location in a location tracking database that stores both said location and timestamp.

6. The method in claim 1, further comprises editing said location identifiers to correspond to actual geo-spatial locations.

7. The method in claim 1, comprising assigning said location identifier based on information other than geo-spatial location.

8. The method in claim 1, wherein said sorting comprises calculating a distance between said location and said location identifiers and ordering said datum by said distance, beginning with a smallest distance.

9. The method in claim 1, wherein the sorting of said document database in a location-dependent order by calculating the distance between current location and said location identifiers associated with said datum in said document database is by logical dimension.

10. A method of sorting geo-spatial dependent data using a global position satellite (GPS)-type client wireless component (CWC), said method comprising:
determining location of said CWC;
accessing a document database whose datum have a location identifiers; and
sorting said document database in a location-dependent order based on a distance between said location of said CWC and said location identifiers associated with said datum in said document database.

11. The method in claim 10, wherein said determining said location of said CWC includes automatic determination by a global position satellite network.

12. The method in claim 10, wherein said determining of said location is by inputting a particular location into the CWC.

13. The method in claim 10, further comprising storing said location into said CWC by inputting said location in a location tracking database that stores both said location and timestamp.

14. The method in claim 10, further comprising editing said location identifier to correspond to geo-spatial location by the GPS-CWC.

15. The method in claim 10, further comprising assigning said location identifier based on information other than geo-spatial location.

16. The method in claim 10, wherein said sorting comprises calculating a distance between said location and said location identifiers and ordering said datum by said distance, beginning with a smallest distance.

17. The method in claim 10, wherein said sorting of said document database in a location-dependent order by calculating the distance between current location and said location identifiers associated with said datum in said document database is by logical dimension based upon user preference.

18. A system for sorting location dependent data, the system comprising: a client wireless component (CWC), the CWC having:
a location tracker operatively configured with a location tracking database;
a document database operatively configured with an editor, a presenter and a recorder, said presenter operatively configured with said location tracking database;
whereby location dependent data used by said CWC is sorted by calculating a distance between a user's location and location identifiers associated with datum in said document database.

19. The system in claim 18, wherein said editor and said recorder comprise editing components that modify said location tracking database.

20. The system in claim 18, wherein said presenter retrieves documents from said document database, and sorts them in location-dependent order for presentation by calculating said distance between current location from said location tracking database and location information associated with each document in said document database.

21. The system in claim 18, wherein said CWC further includes global positioning satellite (GPS) position components and distance determination for sorting said document database is determined by a signal from a GPS network.

22. The system in claim 18, wherein said CWC includes position determining components for sorting said document database, said positioning determining components determine location of said CWC by accessing area code of a local wireless cellular network.

23. A program storage device readable by machine, tangibly embodying a program of instructions executable by said machine to perform a method for sorting location dependent data using a client wireless component, said method comprising:
determining a location of said CWC;
accessing a document database whose datum have a location identifiers; and
sorting said document database in a location-dependent order based on distance between said location of said CWC and said location identifiers associated with said datum in said document database.

24. The program storage device in claim 13, wherein said editing of said document database further includes capability of editing said location identifier associated with said datum determined by actual geo-spatial location.

25. The program storage device in claim 13, wherein the method further said editing of said document database further includes capability of editing said location identifier associated with said datum determined by non-actual geo-spatial location.
